(19) United States
(12) Patent Application Publication
(10) Pub. No.: US 2005/0008157 A1
(43) Pub. Date: Jan. 13, 2005

(54) Method and system for transmitting secret data in a communication network

(76) Inventor: Mikael Hjelm, Vasteras (SE)

Correspondence Address: Andreas Grubert;Baker Botts L.L.P., One Shell Plaza, 910 Louisiana, Houston, TX, 77002-4995, US

(21) Appl. No.: 10/870,769

(22) Filed: Jun. 17, 2004

(30) Foreign Application Priority Data
Jul. 11, 2003 (SE) 0302053-4

(51) Int. Cl. H04K 1/04

(52) U.S. Cl. 380/252

(57) ABSTRACT

A method and a system for transmitting secret data in a communication network are provided. An arbitrary data sequence, which lacks information required for performing channel estimation, is sent to a terminal over a transmission medium. A data sequence, which is identical with the data sequence as it was received by the terminal after having been distorted by the transmission medium is sent back on an identifiable channel. The inverse of the transfer function of the transmission medium is calculated based on the data sequence as transmitted to the terminal, and the data sequence as received from the terminal. Finally, a secret data sequence multiplied with the inverse of the transfer function to compensate for the distortions introduced by the transmission medium is sent to the terminal over the transmission medium, thereby enabling the terminal, but disabling an eavesdropper, to deduce the secret data sequence.

### PRIORITY

This application claims priority to Swedish application no. 0302053-4 filed Jul. 11, 2003.

### TECHNICAL FIELD OF THE INVENTION

The present invention generally relates to the field of communications and more specifically the invention relates to a method and a system for transmitting secret data in a communication network.

### BACKGROUND OF THE INVENTION

In all communication systems today, the need for transfer information in a secure manner is constantly increasing. An eavesdropper is most likely capable of hearing anything communicated between two parties. In wireless systems in particular, this is a problem since the communication can be intercepted without physically connecting to a communication channel. Further, there is often no manner of detecting whether the communication has been intercepted or not.

Provided that the two communication parties can transfer a key of sufficient length, a secure communication channel can be achieved by encrypting the information using the shared key. The problem is now reduced to transfer the shared key in a secure manner.

Quantum encryption provides a technique, by which the key is transmitted without being detectable by a third party eavesdropping between the sender and the receiver without affecting the signal. Quantum encryption uses properties of quantum physics, i.e. the polarization state of a photon cannot be determined unless the measurement is made in the same polarization state, and measuring the polarization state of a photon in an incorrect polarization state will result in loss of knowledge of its initial polarization state. However, quantum encryption is limited to transmission on optical media and to the use of particular devices. Further, it is difficult to transmit polarized photons long distances.

There are other well-known public-key cryptography techniques, such as the well-known Diffie-Hellman-Merkle, RSA, and ElGamal public key cryptography algorithms.

### SUMMARY OF THE INVENTION

It is an object of the present invention to provide a method and a system, respectively, for transmitting secret data, such as encryption key data, in a communication network in a secure manner.

It is in this respect a particular object of the invention to provide such a method and such a system, which overcome the limitations of, or merely constitute alternatives to, the prior art techniques described above.

It is a further object of the invention to provide such a method and such a system, which are reliable, robust and easily implemented, and wherein the encryption is dependent upon the location of the receiver and the medium of the transmission.

It is still a further object of the invention to provide such a method and such a system, which are particularly adapted to be used in wireless networks, such as WLANs.

These objects can according to the present invention be attained by a method for transmitting secret data in a communication network, comprising the steps of:
transmitting to a terminal over a transmission medium a first signal comprising an arbitrary data sequence, the first signal lacking information required for performing channel estimation,
receiving from the terminal a second signal comprising a data sequence, which is identical with the arbitrary data sequence as it was received by the terminal after having been distorted by the transmission medium, and optionally by the terminal, the second signal comprising information required for performing channel estimation,
calculating the inverse of the transfer function of the transmission medium and optional deliberate terminal distortion based on the arbitrary data sequence and the data sequence as received from the terminal, and
transmitting to the terminal over the transmission medium a third signal comprising a secret data sequence multiplied with the inverse of the transfer function to compensate for the transmission medium and optional deliberate terminal distortions, thereby enabling the terminal to deduce the secret data sequence, the third signal lacking information required for performing channel estimation, thereby disabling an eavesdropper to deduce the secret data sequence.

The secret data sequence may comprise a secret key. The communication network can be a wired network, such as an XDSL modulated network. The communication network can be a wireless network, such as a WLAN, a CDSMA-, or a W-CDMA-based network. The data sequence comprised in the second signal received from the terminal can be identical with the arbitrary data sequence as it was received by the terminal after having been distorted by the transmission medium and the terminal, and the transfer function, the inverse of which being calculated based on the arbitrary data sequence as transmitted to the terminal, and the data sequence as received from the terminal, can be the transfer function of the transmission medium and the terminal distortion.

The object can also be achieved by a system for transmitting secret data in a communication network, comprising a first transceiver for transmitting to a second transceiver over a transmission medium a first signal comprising an arbitrary data sequence, the first signal lacking information required for performing channel estimation, wherein the second transceiver is operable to transmit to the first transceiver a second signal comprising a data sequence, which is identical with the arbitrary data sequence as it was received by the second transceiver after having been distorted by the transmission medium and optionally by the second transceiver, the second signal comprising information required for performing channel estimation, wherein the first transceiver is operable to calculate the inverse of a transfer function of the transmission medium and optionally the distortion made by the second transceiver based on the arbitrary data sequence and the data sequence as received from the terminal, and wherein the first transceiver is further operable to transmit to the second transceiver over the transmission medium a third signal comprising a secret data sequence multiplied with the inverse of the transfer function, thereby compensating for the distortions introduced by the transmission medium and optionally the second transceiver, and enabling the second transceiver to deduce the secret data sequence, the third signal lacking information required for performing channel estimation, thereby disabling an eavesdropper to deduce the secret data sequence.

The secret data sequence may comprise a secret key. The communication network can be a wireless network. The wireless network can be a WLAN.

A method for transmitting secret data comprises, according to one aspect of the invention, the following steps. A first signal comprising an arbitrary data sequence, e.g. a randomly selected data sequence, is transmitted to a terminal over a transmission medium wherein the first signal lacks information required for performing channel estimation or assessment, i.e. for calculating the transfer function of the transmission medium for the first signal. A second signal comprising a data sequence, which is identical with the arbitrary data sequence as it was received by the terminal after having been distorted by the transmission medium and possibly by the terminal is received from the terminal, wherein the second signal comprises information required for performing channel estimation.

Next, the inverse of the transfer function of the transmission medium and possibly the terminal distortion, for the first signal is calculated based on the arbitrary data sequence and the data sequence as received from the terminal. Finally, a third signal comprising a secret data sequence, preferably containing encryption key data, multiplied with the inverse of the transfer function to pre-compensate for the distortions introduced by the transmission medium and possibly the terminal distortion is transmitted to the terminal over the transmission medium, wherein the third signal lacks information required for performing channel estimation. If the transmission media for the first and third signals transmitted to the terminal are identical, which requires that the method is performed rapidly enough so the location of the terminal and the surrounding environment do not change during the time between the transmissions, the secret data sequence can be read by terminal in plain text.

Since the transmitted data sequence is completely unknown to everyone but the sender of it and does not contain redundancy to make channel estimation possible, there is no manner to determine the transmitted data sequence from the received distorted data sequence. The transfer function of the transmission medium for transmission to the terminal is used to mask the secret data sequence, thereby enabling the terminal to read the secret data sequence in plain text.

Since the transfer functions differ from one terminal to another in the network an eavesdropper cannot read the secret data sequence. The eavesdropper has no capabilities of deducing the arbitrary data sequence, nor the transfer function. As a consequence, neither the secret data sequence can be deduced.

Preferably, the invention is implemented in a wireless network such as a WLAN, wherein the signals are heavily distorted by the transmission medium, i.e. the air. Thus, the transfer functions differ heavily from one terminal to another.

Further characteristics of the invention, and advantages thereof, will be evident from the following detailed description of preferred embodiments of the present invention given hereinafter and the accompanying FIGS. 1-2, which are given by way of illustration only, and shall thus not limit the scope of the present invention.

### BRIEF DESCRIPTION OF THE DRAWING

FIG. 1 is a schematic illustration of three terminals connected in a WLAN, wherein the transfer functions for a signal sent from one of the terminals to the two others are indicated.

FIG. 2 is a schematic flow diagram illustrating a method for secure transmission according to a preferred embodiment of the present invention.

### DETAILED DESCRIPTION OF EMBODIMENTS

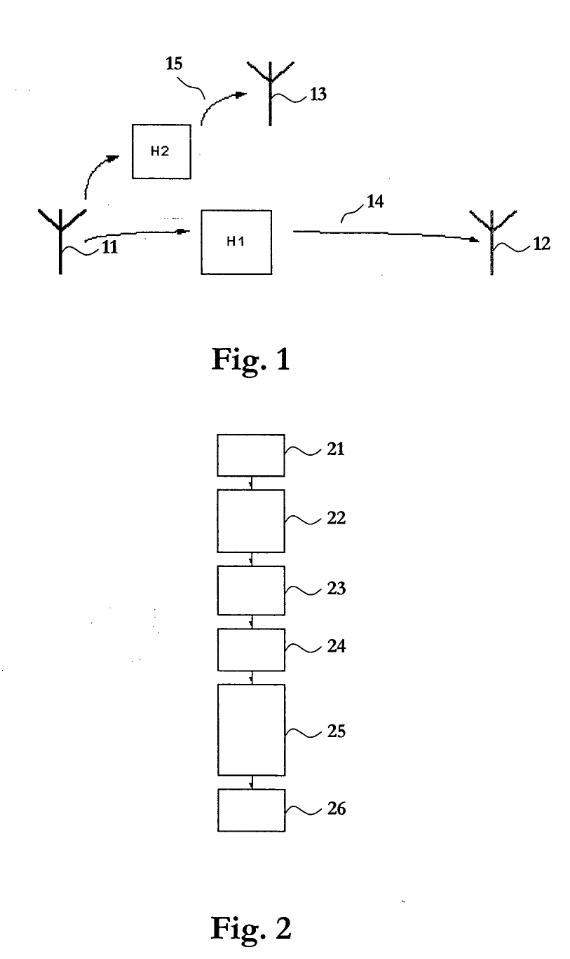

FIG. 1 illustrates a first 11, a second 12 and a third 13 terminal or transceiver connected in a WLAN, wherein a signal is sent from the first terminal 11 over the air to be received by the second terminal 12. Typically, however, the third terminal 13, which may be an eavesdropper, can also hear the signal. Since the air-bound signal is affected by the surroundings, particularly any obstacles in its way, it looks very different to the second and third terminals 12, 13 since they are located at different places. In FIG. 1 the signal paths from the transmitting terminal 11 to the second and third terminals 12, 13 are schematically indicated by arrows 14, 15.

A transfer function H₁, H₂ can be associated to each of the signal paths 14, 15 for the signal transmitted from the terminal 11, where the respective transfer function H₁, H₂ indicates how the distortion by the transmission medium affects the signal, i.e. provided that A is the signal transmitted by the first terminal 11, the second terminal 12 will receive the distorted signal A₁H₁ and the third terminal 13 will receive the distorted signal A₁H₂. In wireless networks, the transfer functions H₁, H₂ are typically quite different.

The invention uses the volatile and unknown transfer functions of the transmission medium. Provided that the transmitted information is completely unknown and does not contain redundancy to make channel estimation possible, there is no way to know what the received information was transmitted as. This is used in the present invention to mask the secret data.

With reference to FIG. 2, which is a schematic flow diagram illustrating a method for secure transmission, a preferred embodiment of the present invention will be depicted.

The first terminal 11 transmits, in a step 21, a first signal containing an arbitrary data sequence A₁ over the air. The arbitrary data sequence A₁ is preferably a randomly selected data sequence, which has no relation to any previously transmitted data. The first signal lacks information required for performing channel estimation, i.e. known data code for calculating the transfer function of the transmission medium for the first signal.

The second terminal 12 receives, in a step 22, the first signal. The data sequence contained in the received signal is now altered by the transfer function H₁ and the second terminal 12 receives therefore the data sequence A₁H₁. An eavesdropper, i.e. the third terminal 13 receives the data A₁H₂ and provided that the transfer function H₂ induces sufficient distortion, the third terminal 13 cannot discern any information regarding the originally sent arbitrary data sequence A₁. Naturally, provided that the transfer function H₁ induces sufficient distortion, the second terminal 12 cannot either discern the arbitrary data sequence A₁.

Next, the second terminal 12 transmits, in a step 23, a second signal back to the first terminal 11 over an unsecured channel, i.e. using a standard protocol to enable channel estimation. The second signal contains the received distorted data sequence A₁H₁.

If the third terminal 13 hears this signal, the only information it can deduce is the received distorted data sequence A₁H₁. However, this does not provide the third terminal 13 with any useful information. The first terminal 11, on the other hand, can calculate the transfer function H₁ and its inverse H₁⁻¹ from the known transmitted arbitrary data sequence A₁ and the received distorted data sequence A₁H₁.

When the first terminal 11 has received the second signal and retrieved the distorted data sequence A₁H₁, it thus computes, in a step 24, the inverse of the transfer function H₁⁻¹ based on the arbitrary data sequence A₁ and the distorted data sequence A₁H₁. The first terminal 11 then pre-compensates for the transfer function H₁. Supposing that a secret data sequence K, e.g. an encryption key, is to be sent to the second terminal 12, the first terminal 11 calculates the pre-compensated data sequence KH₁⁻¹.

Then, the first terminal 11 transmits, in a step 25, a third signal containing the secret data sequence K pre-compensated with the inverse of the transfer function H₁⁻¹, i.e. the data sequence KH₁⁻¹ in a manner so as to make channel estimation impossible.

The second terminal 12 can then, in a step 26, when receiving the third signal read the secret data sequence K in plain text since the result of the distortion on the data sequence KH₁⁻¹ introduced by the transmission medium is KH₁⁻¹H₁=K. The third terminal 13, i.e. the eavesdropper, reads the data sequence KH₁⁻¹H₂, which is not the same as K provided that H₁ and H₂ differ. The present invention is based on the fact that different receivers experience different transfer functions.

Further, the inaccuracies of the receiver are also included in the transfer function which makes the transfer function receiver dependent.

An advantage of the present invention is the possibility of transferring secret data over an unsecured medium. The security increases with the distance between the transmitting and receiving terminals since the transfer functions differ more over long distances. The invention is primarily intended to be used in WLANs, but is applicable to any kind of network—wireless as well as wired networks provided that the transfer functions of the transmission medium differs sufficiently from place to place. A non-exhaustive list of networks, in which the present invention is applicable, includes ADSL, VDSL, XDSL CDSMA and W-CDMA networks.

Further, the invention may include transmissions on another unsecured channel to synchronize the first terminal 11 and the second terminal 12 so that the second terminal 12 knows when the first and possibly the third signals are transmitted.

In a WLAN, the transmitting terminal 11, which may be an access point, transmits data according to a standard WLAN protocol. The second terminal 12, which may be a mobile station, requests association, i.e. allowance to use the access point 11. The access point 11 informs the mobile station 12 when and how, i.e. on which channel, it is to send the first signal containing the arbitrary data sequence A1. The first signal is then sent in a non-standardized manner, i.e. in a manner, which makes channel estimation impossible. The second signal may be sent in plain text, i.e. sent according to the WLAN standard. However, the third signal has to be sent in the same manner as the first signal. When the secret data sequence, which in this case is a key, has been transmitted, the communication may begin on a normal WLAN channel using the key according to a WLAN encryption protocol.

The first and third signals may be transmitted in the same frequency band as used by WLAN standards, using e.g. OFDM or cck modulation, and using the same hardware.

Still further, the invention may include the deliberate addition of a further distortion at the receiver end, which has to be made with respect to both the first and third signals. Hereby, the probability that the second terminal 12 can receive the secret data sequence K in plain text is decreased since it will be less likely that the third and second terminals 13, 12 will have similar transfer functions.

If the second terminal 12 adds a distortion having a transfer function H₃, the first terminal does not have to obtain information of it since as far as it concerns the first terminal the procedure is identical with the one depicted above. The second terminal 12 will, in the step 23, transmit to the first terminal 11 the data sequence A₁H₁H₃ in the second signal, and the first terminal 11 will, in the step 24, compute the inverse of the transfer function H₁H₃ and, in the step 25, transmit to the second terminal 12 the pre-compensated data sequence K(H₁H₃)⁻¹ in the third signal. The second terminal 12 applies the distortion H₃ once more when receiving the third signal, and will thus, in the step 26, receive the data sequence K(H₁H₃)⁻¹H₁H₃=K.

Yet further, the invention may include the use of active antennas of the first terminal 11. Information as to the direction from the first terminal 11 to the second terminal 12 can be retrieved, e.g. from the data the second terminal 12 sends back to the first terminal 11. Then, the directional information can be used for tuning the antennas to further decrease the risk that an eavesdropper can hear the secret data.

1. A method for transmitting secret data in a communication network, comprising the steps of:
transmitting to a terminal over a transmission medium a first signal comprising an arbitrary data sequence, said first signal lacking information required for performing channel estimation,
receiving from said terminal a second signal comprising a data sequence, which is identical with the arbitrary data sequence as it was received by the terminal after having been distorted by said transmission medium, and optionally by said terminal, said second signal comprising information required for performing channel estimation,
calculating the inverse of the transfer function of said transmission medium and optional deliberate terminal distortion based on said arbitrary data sequence and said data sequence as received from said terminal, and
transmitting to said terminal over said transmission medium a third signal comprising a secret data sequence multiplied with the inverse of said transfer function to compensate for said transmission medium and optional deliberate terminal distortions, thereby enabling said terminal to deduce said secret data sequence, said third signal lacking information required for performing channel estimation, thereby disabling an eavesdropper to deduce said secret data sequence.

2. The method of claim 1, wherein said secret data sequence comprises a secret key.

3. The method of claim 1, wherein said communication network is a wired network, such as an XDSL modulated network.

4. The method of claim 2, wherein said communication network is a wired network, such as an XDSL modulated network.

5. The method of claim 1, wherein said communication network is a wireless network, such as a WLAN, a CDSMA-, or a W-CDMA-based network.

6. The method of claim 2, wherein said communication network is a wireless network, such as a WLAN, a CDSMA-, or a W-CDMA-based network.

7. The method of claim 1, wherein
said data sequence comprised in said second signal received from said terminal is identical with the arbitrary data sequence as it was received by the terminal after having been distorted by said transmission medium and said terminal, and
said transfer function, the inverse of which being calculated based on said arbitrary data sequence as transmitted to said terminal, and said data sequence as received from said terminal, is the transfer function of said transmission medium and said terminal distortion.

8. A system for transmitting secret data in a communication network, comprising:
a first transceiver for transmitting to a second transceiver over a transmission medium a first signal comprising an arbitrary data sequence, said first signal lacking information required for performing channel estimation,
wherein said second transceiver is operable to transmit to said first transceiver a second signal comprising a data sequence, which is identical with the arbitrary data sequence as it was received by said second transceiver after having been distorted by said transmission medium and optionally by said second transceiver, said second signal comprising information required for performing channel estimation,
wherein said first transceiver is operable to calculate the inverse of a transfer function of said transmission medium and optionally said distortion made by said second transceiver based on said arbitrary data sequence and said data sequence as received from said terminal, and wherein
said first transceiver is further operable to transmit to said second transceiver over said transmission medium a third signal comprising a secret data sequence multiplied with the inverse of said transfer function, thereby compensating for the distortions introduced by said transmission medium and optionally said second transceiver, and enabling said second transceiver to deduce said secret data sequence, said third signal lacking information required for performing channel estimation, thereby disabling an eavesdropper to deduce said secret data sequence.

9. The system of claim 8, wherein said secret data sequence comprises a secret key.

10. The system of claim 8, wherein said communication network is a wireless network.

11. The system of claim 9, wherein said communication network is a wireless network.

12. The system of claim 10, wherein said wireless network is a WLAN.

13. The system of claim 11, wherein said wireless network is a WLAN.

14. A system for transmitting secret data in a communication network, comprising:
a first transceiver,
a second transceiver, coupled with said first transceiver via a transmission medium, wherein
said first transceiver is operable to transmit to said second transceiver a first signal comprising an arbitrary data sequence, said first signal lacking information required for performing channel estimation,
wherein said second transceiver is operable to transmit to said first transceiver a second signal comprising a data sequence, which is identical with the arbitrary data sequence as it was received by said second transceiver after having been distorted by said transmission medium and optionally by said second transceiver, said second signal comprising information required for performing channel estimation,
wherein said first transceiver is operable to calculate the inverse of a transfer function of said transmission medium and optionally said distortion made by said second transceiver based on said arbitrary data sequence and said data sequence as received from said terminal, and wherein
said first transceiver is further operable to transmit to said second transceiver over said transmission medium a third signal comprising a secret data sequence multiplied with the inverse of said transfer function, thereby compensating for the distortions introduced by said transmission medium and optionally said second transceiver, and enabling said second transceiver to deduce said secret data sequence, said third signal lacking information required for performing channel estimation, thereby disabling an eavesdropper to deduce said secret data sequence.

15. The system of claim 14, wherein said secret data sequence comprises a secret key.

16. The system of claim 14, wherein said communication network is a wireless network.

17. The system of claim 15, wherein said communication network is a wireless network.

18. The system of claim 16, wherein said wireless network is a WLAN.

19. The system of claim 17, wherein said wireless network is a WLAN.
